(19) United States
(12) Patent Application Publication
(10) Pub. No.: US 2018/0370584 A1
(43) Pub. Date: Dec. 27, 2018

(54) MOVING OBJECT WITH COMBINED MOVEMENT

(71) Applicant: SOFTBANK ROBOTICS EUROPE, PARIS (FR)

(72) Inventor: Vincent CLERC, CLAMART (FR)

(21) Appl. No.: 16/063,204

(22) PCT Filed: Dec. 13, 2016
(86) PCT No.: PCT/EP2016/080770

§ 371 Date: Jun. 15, 2018

(30) Foreign Application Priority Data
Dec. 16, 2015 (FR) 1562534

(51) Int. Cl. B62D 57/02; G03B 17/02; G03B 37/02

(52) U.S. Cl. CPC B62D 57/02; B60B 19/12; G03B 37/02; G03B 17/02

(57) ABSTRACT

A mobile that can move on a horizontal plane, including a body comprising a contact area in contact with the horizontal plane, a cam movable in rotation relative to the body about a cam axis, the cam having a contact surface in contact with the horizontal plane during its rotation. According to the invention, the contact surface of the cam comprises separate first and second portions, each of the first and second portions having a different coefficient of friction, the coefficient of friction of the first portion being greater than the coefficient of friction of the second portion, the first portion being configured to roll without slipping on the horizontal plane, the second portion being configured to slip without rolling on the horizontal plane, and in that the body is configured to rotate relative to the horizontal plane about a vertical axis perpendicular to the cam axis when the first portion rolls without slipping on the horizontal plane and to rotate relative to the horizontal plane about a horizontal axis perpendicular to the cam axis and to the vertical axis when the second portion slips without rolling on the horizontal plane.

The invention is in the field of the setting into motion of an object and concerns a mobile with combined movement with a simple structure.

The invention consists generally in causing an object to turn about two rotation axes: rotation on itself about a vertical axis and rotation about an axis perpendicular to the vertical axis. In other words, the invention consists in setting an object in motion so that it can rotate about its axis in conjunction with a second rotation.

The invention can find an application in imaging. For example, it may be desirable to obtain a 360° image around an object. This may be the case for a safety device that consists in viewing a space such as a room in which it is desired to be sure that there is no intrusion. To this end, it then suffices to render the object mobile in rotation on itself. The object provided with an image capture device can produce in the form of images a representation of its environment in the form of a strip (the height of this strip depending on the height of view that the image capture device is able to produce). In order to have an image representing the surrounding three-dimensional space, it is advantageous, in addition to the 360° view around the object, to have additional information, beyond the height of the strip. In addition to the rotation on itself, it is then necessary for the object to be able to scan vertically, for example by moving vertically in translation to allow a three-dimensional graphical representation of its environment to be obtained.

There exist various solutions for causing rotation and translation of an object. For example, a motor can render an object mobile in rotation about its axis. Another motor can enable the object to be mobile in translation along a predefined axis. This solution therefore necessitates the presence of two motors, which can be bulky, complex and costly.

Another solution consists in utilizing a single motor to cause the rotation and the translation. The motor renders the object mobile in rotation about its axis and thanks to a mechanism including a cam and a camshaft, the same motor can generate a translation of the object. This solution undoubtedly requires only one motor but nevertheless necessitates a mechanism comprising a plurality of parts, sometimes complex to implement.

The invention aims to alleviate some or all of the problems cited above by proposing a mobile of very simple structure, relatively compact and of relatively low cost, not necessitating any particular maintenance, enabling an object to be mobile in rotation on itself, about a vertical axis, and to add to that rotation another rotation about an axis perpendicular to the vertical axis. The rotation about the vertical axis allows scanning of a room in the horizontal plane, the second rotation about an axis perpendicular to the vertical axis allows scanning in the vertical plane, and it is then possible to effect the two types of rotation successively in turn.

To this end, the invention consists in a mobile that can move on a horizontal plane, comprising a body comprising a contact area in contact with the horizontal plane, a cam movable in rotation relative to the body about a cam axis, the cam having a contact surface in contact with the horizontal plane during its rotation, characterized in that the contact surface of the cam comprises separate first and second portions, each of the first and second portions having a different coefficient of friction, the coefficient of friction of the first portion being greater than the coefficient of friction of the second portion, the first portion being configured to roll without slipping on the horizontal plane, the second portion being configured to slip without rolling on the horizontal plane, and in that the body is configured to rotate relative to the horizontal plane about a vertical axis perpendicular to the cam axis when the first portion rolls without slipping on the horizontal plane and to rotate relative to the horizontal plane about a horizontal axis perpendicular to the cam axis and to the vertical axis when the second portion slips without rolling on the horizontal plane.

The cam is advantageously eccentric about the cam axis.

According to one embodiment, the cam is a cylindrical wheel about a wheel axis, the cam axis being off-center relative to the wheel axis.

The first portion advantageously extends over a first angular sector about the cam axis, and the first angular sector has a constant radius about the cam axis.

The second portion advantageously extends over a second angular sector about the cam axis distinct from the first angular sector, defining two junction zones between the first angular sector and the second angular sector, and the radii relative to the cam axis of the first angular sector and the second angular sector vary continuously at the level of the two junction zones.

The second angular sector advantageously comprises two zones of linear variation of the radius relative to an angle that the radius makes about the cam axis, a first of the two zones having a radius that increases linearly and a second of the two zones having a radius that decreases linearly.

According to another embodiment, the contact area forms two individual points of contact with the horizontal plane.

The contact area advantageously comprises two castors, and the two castors form the two individual points of contact with the horizontal plane.

According to another embodiment, the body is configured so that the contact area forms a point of contact with the horizontal plane.

According to this embodiment, the center of gravity of the mobile is advantageously situated on a vertical axis passing between the contact surface of the cam in contact with the horizontal plane and the contact area when the first portion rolls without slipping on the horizontal plane.

The first position and the second portion of the rolling surface of the cam each having a width, the width of the first portion is advantageously greater than the width of the second portion.

According to another embodiment, the mobile comprises at least one image capture device oriented along an orientation axis, able to produce an image of a sector situated around the orientation axis.

The mobile advantageously comprises a digital image storage medium.

The digital image storage medium is advantageously part of the cam.

The cam is advantageously removable.

According to another embodiment, the body comprises a USB port situated substantially on the cam axis, and the cam forms a USB key intended to be plugged into the USB port.

The digital image storage medium is advantageously able to back up a succession of images produced as and when the cam rotates about the cam axis.

The invention will be better understood and other advantages will appear on reading the detailed description of an embodiment given by way of example, description illustrated by the appended drawing in which:

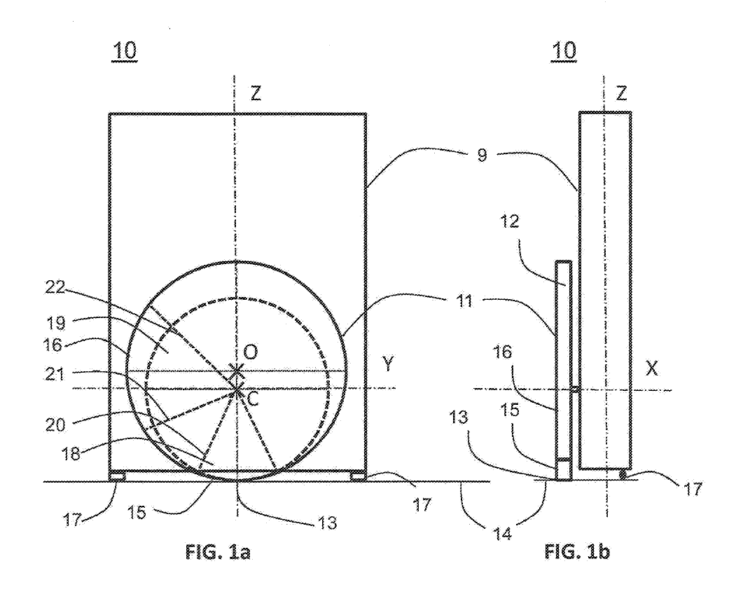

FIGS. 1a and 1b represent schematically an embodiment of a mobile with combined movement according to the invention,

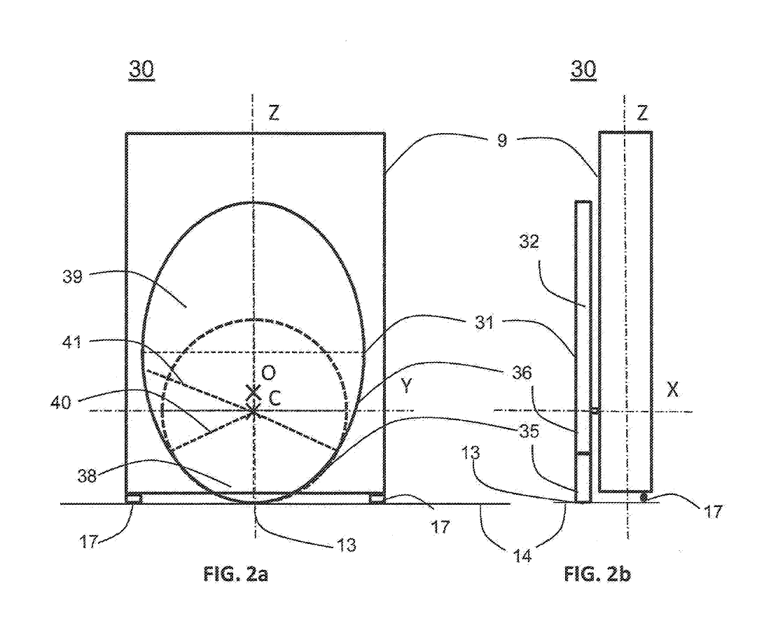

FIGS. 2a and 2b represent schematically another embodiment of the mobile with combined movement according to the invention,

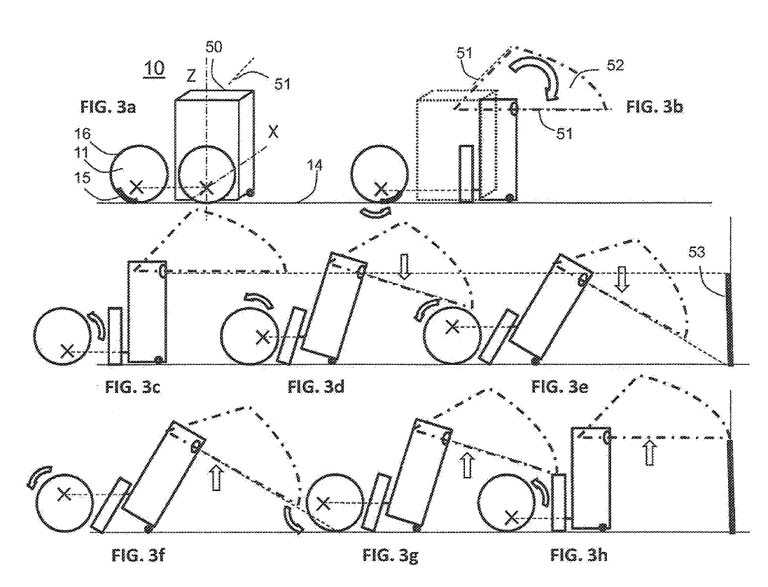

FIGS. 3a, 3b, 3c, 3d, 3e, 3f, 3g, 3h represent schematically an operating cycle of the mobile with combined movement according to the invention,

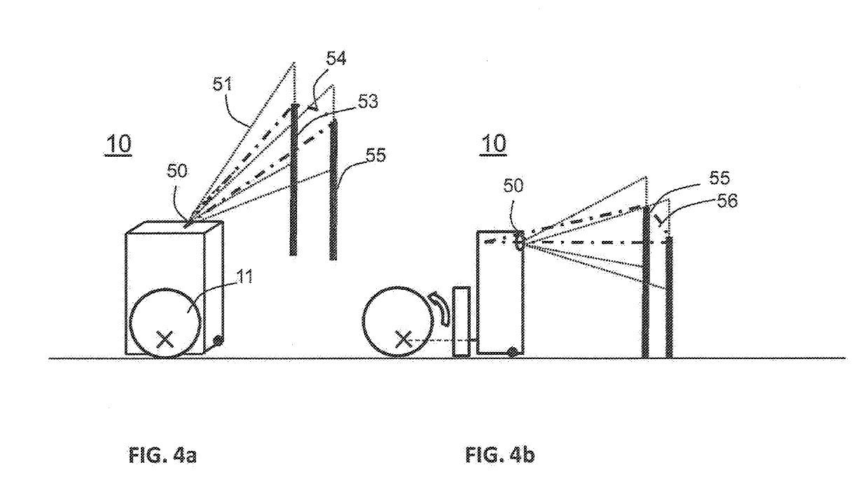

FIGS. 4a and 4b represent schematically the views taken by the mobile with combined movement according to the invention, after two operating cycles,

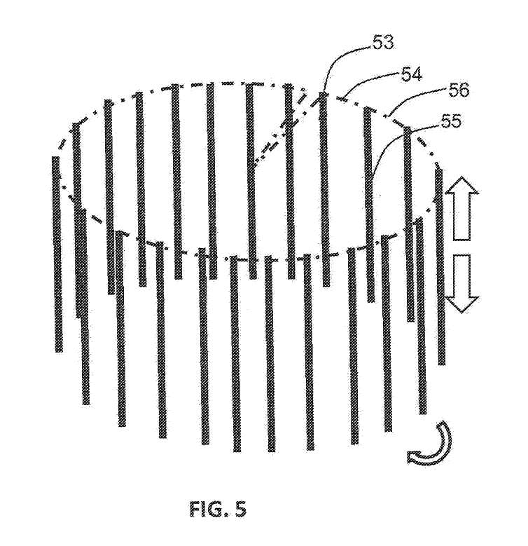

FIG. 5 represents schematically the totality of the views taken by the mobile with combined movement according to the invention, after a plurality of operating cycles, corresponding to a 360° rotation of the mobile on itself,

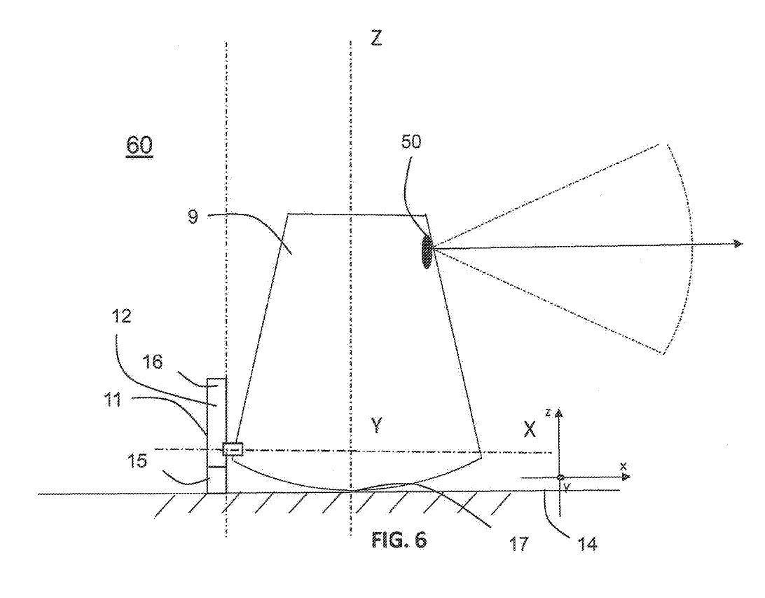

FIGS. 6, 7, 8 represent schematically another embodiment of the mobile with combined movement according to the invention,

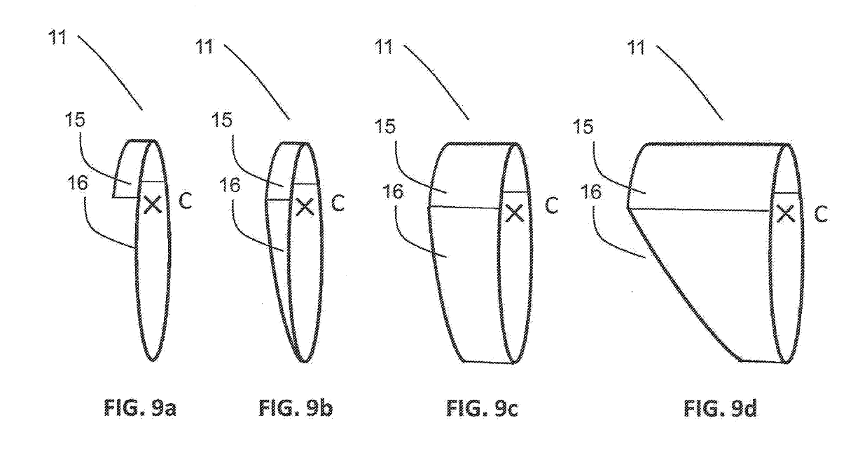

FIGS. 9a, 9b, 9c, 9d represent schematically various cam configurations according to the invention.

For clarity, the same elements bear the same references in the various figures.

The invention concerns a mobile with combined movement. By mobile is meant any object able to be moved. The mobile may be for example a vehicle.

FIGS. 1a and 1b represent schematically one embodiment of a mobile 10 with combined movement according to the invention. FIG. 1a represents a rear view, FIG. 1b represents a profile view of the mobile 10. The mobile 10 with combined movement can be moved on a horizontal plane 14. The mobile 10 comprises a body 9 comprising a contact area 17 in contact with the horizontal plane 14. The mobile 10 with combined movement comprises a cam 11 movable in rotation relative to the body 9 about a cam axis X. The cam 11 has a contact surface 12 in contact with the horizontal plane 14 during its rotation. The cam 11 may also comprise a motor unit intended to drive the cam 11 in rotation about the cam axis X so that the mobile 10 is moved on the reference plane 14, or any other means enabling the cam 11 to be set in rotation. According to the invention, the contact surface 12 of the cam 11 comprises a first portion 15 and a second portion 16 that are distinct, each of the first and second portions 15, 16 having a different coefficient of friction, the coefficient of friction of the first portion 15 being greater than the coefficient of friction of the second portion 16, the first portion 15 being configured to roll without slipping on the horizontal plane 14, the second portion 16 being configured to slip without rolling on the horizontal plane 14 when the cam 11 is driven in rotation about the second rotation axis X. The body 9 is configured to rotate relative to the horizontal plane 14 about a vertical axis Z perpendicular to the cam axis X when the first portion 15 rolls without slipping on the horizontal plane 14 and to rotate relative to the horizontal plane 14 about a horizontal axis Y perpendicular to the cam axis X and to the vertical axis Z when the second portion 16 slips without rolling on the horizontal plane 14.

In other words, the contact area 17 of the mobile 10 with combined movement is configured to be moved on the horizontal plane 14 when the first portion 15 rolls without slipping on the horizontal plane 14 and to adhere to the horizontal plane 14 when the second portion 16 slips without rolling on the horizontal plane 14.

For example, the first portion 15 may be rough and the second portion 16 may be smooth.

If there is considered the force F that the cam exerts on the horizontal plane, there exists a resultant vector R forming an angle Phi with the weight vector of the mobile. The angle Phi defines the friction cone. The coefficient of friction of the mobile on the horizontal plane is therefore defined by tan Phi (tangent of the angle Phi). The mobile is moved if a force F0 exerted by the cam on the horizontal plane becomes greater than the value F of the force so that the resultant vector R0 forms with the weight vector an angle Phi0 greater than Phi, that is to say so that the resultant vector R0 leaves the friction cone.

In other words, the fact that the first portion 15 is configured to roll without slipping on the horizontal plane 14 and the contact area 17 of the mobile 10 is configured to move on the horizontal plane 14 when the first portion 15 rolls without slipping on the horizontal plane 14 means that the force F1 that the cam exerts on the horizontal plane is greater than the force F that would cause the resultant of one of the points of the contact area 17 to leave its respective friction cone.

Where the second portion 16 configured to slip without rolling on the horizontal plane 14 when the cam 11 is driven in rotation about the second rotation axis X is concerned, the force F1 that the cam exerts on the horizontal plane is less than the force F. The resultant of each of the individual points of the contact area 17 does not leave its respective friction cone. And the contact area 17 adheres to the horizontal plane 14 when the second portion 16 slips without rolling on the horizontal plane 14.

According to one embodiment, the cam 11 may be eccentric about the cam axis X.

According to one embodiment, the cam 11 may be a cylindrical wheel about a wheel axis, the cam axis X being off-center relative to the wheel axis, as shown in FIG. 1a, the point O being the center of the wheel and the point C being the point of intersection of the cam axis X with the cam 11. This embodiment has the advantage of being simple to manufacture.

The first portion 15 extends over a first angular sector 18 about the cam axis X, and the first angular sector 18 has a constant radius about the cam axis X.

The second portion 16 extends over a second angular sector 19 about the cam axis X distinct from the first angular sector 18, defining two junction zones between the first and second angular sectors 18, 19, and the radii relative to the cam axis X of the first and second angular sectors 18, 19 vary continuously at the level of the two junction zones. Accordingly, despite the variation of the radii between the two angular sectors 18, 19, the rotation of the cam 11 is smooth when there is a transition in the contact of the cam 11 with the horizontal plane 14 from the first angular sector 18 to the second angular sector 19.

According to one embodiment, the contact area 17 forms two individual points of contact with the horizontal plane. The contact area 17 may advantageously comprise two castors and the two castors form the two individual points of contact with the horizontal plane 14. The two castors 17 in contact with the reference plane 14 facilitate the mobility in rotation of the mobile 10 when the first portion 15 of the cam 11 rolls on the horizontal plane 14. The two castors can have a contact surface the coating of which is adapted as a function of the roughness of the horizontal plane 14 in such a fashion as to obtain the desired mobility of the mobile 10 with combined movement. Still within the scope of the invention is a contact area 17 with three or more points of contact, it being possible for those points of contact to be only castors and/or only bearing points. The contact area 17 may also be a surface contact area or even a plurality of surface contact areas, for example a leg of parallelepiped shape of chair leg type, the covering of which is adapted to allow rolling and slipping of this zone on the horizontal plane 14.

FIGS. 2a and 2b represent schematically another embodiment of a mobile 30 with combined movement according to the invention. The mobile 30 is identical to the mobile 10 shown in FIGS. 1a and 1b. In fact the mobile 30 with combined movement may be moved on a horizontal plane 14. The mobile 30 comprises a body 9 comprising a contact area 17 in contact with the horizontal plane 14. The mobile 30 with combined movement comprises a cam 31 movable in rotation relative to the body 9 about a cam axis X. The cam 31 has a contact surface 32 in contact with the horizontal plane 14 during its rotation. The cam 31 may also comprise a motor unit intended to drive the cam 31 in rotation about the cam axis X in such a fashion that the mobile 30 is moved on the reference plane 14, or any other means enabling the cam 31 to be set in rotation. According to the invention, the contact surface 32 of the cam 31 comprises a first portion 35 and a second portion 36 that are distinct, each of the first and second portions 35, 36 having a different coefficient of friction, the coefficient of friction of the first portion 35 being greater than the coefficient of friction of the second portion 36, the first portion 35 being configured to roll without slipping on the horizontal plane 14, the second portion 36 being configured to slip without rolling on the horizontal plane 14 when the cam 31 is driven in rotation about the second rotation axis X. The contact area 17 of the mobile 30 with combined movement is configured to be moved on the horizontal plane 14 when the first portion 35 rolls without slipping on the horizontal plane 14 and to adhere to the horizontal plane 14 when the second portion 36 slips without rolling on the horizontal plane 14. The body 9 is therefore configured to rotate relative to the horizontal plane 14 about a vertical axis Z perpendicular to the cam axis X when the first portion 35 rolls without slipping on the horizontal plane 14 and to rotate relative to the horizontal plane 14 about a horizontal axis Y perpendicular to the cam axis X and to the vertical axis Z when the second portion 36 slips without rolling on the horizontal plane 14.

The mobile 30 differs from the mobile 10 in that the cam 31 is not of circular shape. In fact, it is still within the scope of the invention to consider a cam 31 of elliptical or ovoid shape. The contact surface 32 must just be curved in such a fashion as to allow rotation of the cam 31. The first portion 35 extends over a first angular sector 38 about the cam axis X, and the first angular sector 38 has a constant radius.

The second portion 36 extends over a second angular sector 39 about the cam axis X distinct from the first angular sector 38, defining two junction zones between the first and second angular sectors 38, 39, and the radii 40, 41 of the first and second angular sectors 38, 39 vary continuously at the level of the two junction zones, allowing smooth rotation of the cam 31 despite the different radii between the two angular sectors 38, 39.

The second angular sector 39 may comprise two zones of linear variation of the radius relative to an angle that the radius makes about the cam axis X, a first of the two zones having a radius that increases linearly and a second of the two zones having a radius that decreases linearly. As represented in FIG. 2a, the second angular sector 39 has, starting from the first angular sector 38 and going toward the vertical represented by a vertical axis Z perpendicular to the cam axis X, a succession of increasing radii. This configuration is particularly advantageous, as explained below, but the invention also concerns any other cam configuration with different evolutions of its radii.

Moreover, the second angular sector 39 may comprise a junction zone between the two zones of linear variation for which the radius is constant. The result of this is, while the cam 31 is slipping without rolling when this zone is in contact with the horizontal plane 14, that the body is no longer in motion during the time of contact between the horizontal plane 14 and this cam zone 31. In other words, during this time, the mobile 30 neither rotates nor moves in translation. This configuration can allow the mobile 30 to have a delay loop in its operating cycle.

A result of this is that the mobile 10 is mobile in rotation about the vertical axis Z when the cam 11, mobile in rotation about the cam axis X, is in contact with the reference plane 14 at the level of its first portion 15, by friction effect by adhesion of the cam 11 on the reference plane 14, the contact area 17 of the mobile 10 being configured to be moved on the horizontal plane 14 when the first portion 15 rolls without slipping on the horizontal plane 14. On turning about the cam axis X, there comes a time when the cam 11 is in contact with the reference plane 14 at the level of its second portion 16. As the contact surface 12 of the cam 11 is configured to slip without rolling, there is no longer any friction by adhesion, the contact area 17 of the mobile 10 being configured to adhere to the horizontal plane 14 when the second portion 16 slips without rolling on the horizontal plane 14. The cam 11 slips at the level of the contact point. Because of this, the mobile 10 is no longer mobile in rotation about the vertical axis Z.

As the cam 11 is eccentric and the second angular sector 19 has two zones of linear variation of radius, it follows that, when the cam 11 is mobile in rotation about the cam axis X and in contact with the horizontal plane 14 at the level of the second portion 16, the cam 11 slips without rolling on the horizontal plane 14 and the body 9 connected to the cam 11 at the level of the cam axis of the cam 21 rotates about the axis Y. To be more precise, as the contact with the horizontal plane 14 is at the level of the cam 11 and of the contact area 17, the upper part of the mobile 10 moves in translation. The translation effected is determined by the offset of the point C relative to the point O.

Thus there are distinguished two phases of movement during a cycle of rotation about the cam axis: a first phase of rotation about the vertical axis Z when the first portion 15 is in contact with the horizontal plane 14 and a second phase of rotation of the body 9 about the axis Y when the second portion 16 is in contact with the horizontal plane.

Note that the invention also applies to a cam of circular and non-eccentric shape, that is to say to a wheel. In this case, the second phase is a phase of immobilization of the mobile 10.

FIGS. 3a, 3b, 3c, 3d, 3e, 3f, 3g, 3h represent schematically an operating cycle of the mobile 10 with combined movement according to the invention, corresponding to a cycle of rotation of the cam 11 about the cam axis. The mobile 10 may comprise at least one image capture device 50 oriented along an orientation axis 51, able to produce an image of a sector situated around the orientation axis 51. The invention is described here with the orientation axis substantially parallel to the cam axis X, but it is obvious that the invention applies by analogy to any orientation axis parallel or not to the cam axis X.

FIGS. 3a and 3b represent the first phase of rotation. The cam 11 is in contact with the horizontal plane 14 at the level of the first portion 15. The cam 11 and therefore the mobile 10 roll on the horizontal plane 14, without slipping. In FIG. 3b, the mobile 10 is at the end of the first phase of rotation. The cam 11 stops rotating on the first portion 15. The orientation axis 51 has scanned the sector 52 during the rotation of the cam 11 on the first portion 15. During the rotation of the cam 11 on the first portion 15, the image capture device 50 has produced one image or advantageously a plurality of images of the zone situated around the orientation axis 51. The frequency at which images are taken may be adapted in such a fashion as to obtain a series of images representing the environment of the mobile 10. The frequency may for example be adapted as a function of the angular speed of the cam 11.

FIGS. 3c to 3h represent the second phase of rotation of the body about the axis Y. The cam 11 is in contact with the horizontal plane 14 at the level of the second portion 16. The cam 11 and therefore the mobile 10 slip on the horizontal plane 14, without rolling. The upper part of the mobile 10 moves in vertical translation. In other words, the mobile 10 is in a tilted position. In FIG. 3e, the mobile 10 is in the middle of the second phase of rotation, corresponding to obtaining a maximum translation. The orientation axis 51 has scanned the sector 53 during the rotation of the cam 11 on the second portion 16. During the rotation of the cam 11 on the second portion 16, the image capture device 50 has produced one image or advantageously a plurality of images of the zone situated around the orientation axis 51. The frequency at which images are taken may be adapted in such a fashion as to obtain a series of images representing the environment of the mobile 10. The frequency can for example be adapted as a function of the angular speed of the cam 11, and is not necessarily the same as the frequency used during the first phase of rotation.

FIGS. 3f to 3h represent the return of the mobile 10 from its tilted position to its vertical position. The image capture device 50 may produce images throughout the second phase of rotation or only during the first part of that phase when the mobile 10 goes from a vertical position to a tilted position or only during the second part of that phase when the mobile 10 goes from a tilted position to a vertical position.

FIGS. 4a and 4b represent schematically the views taken by the mobile 10 with combined movement according to the invention, after two operating cycles. Each cycle is composed of two rotations, one resulting in a movement in vertical translation and the other in a rotation. In FIG. 4a, the mobile 10 has effected a first cycle allowing vertical scanning of the sector 53 and scanning of the sector 54 by rotation. In FIG. 4b, the mobile 10 has effected a second cycle allowing vertical scanning of the sector 55 and scanning of the sector 56 by rotation.

It may be recalled that the invention also applies for a cam of circular and non-eccentric shape, that is to say for a wheel. In this case, the second phase is a phase of immobilization of the mobile 10. In this particular case, the mobile 10 scans only the sectors 54 and 56. The phases of immobilization of the mobile 10 can then serve as a delay loop for example to allow the mobile 10 to transmit the images produced during the rotation phase to an exterior storage medium via a wireless connection.

FIG. 5 represents schematically all of the views taken by the mobile 10 with combined movement according to the invention, after a plurality of operating cycles, corresponding to a 360° rotation of the mobile 10 on itself. As explained above, the mobile 10 has effected a first cycle allowing vertical scanning of the sector 53 and scanning of the sector 54 by rotation. Then, the mobile 10 has effected a second cycle allowing vertical scanning of the sector 55 and scanning of the sector 56 by rotation. After a succession of operating cycles, that is to say after several complete rotations of the cam 11, the image capture device 50 of the mobile 10 has scanned the sectors represented in FIG. 5. Thus the mobile 10 allows a three-dimensional graphical representation of its environment to be obtained. This graphical representation may be more or less refined depending on the capability of the image capture device to produce a wider or narrower image around the orientation axis 51. Likewise, it is possible to adapt the shape of the cam 11 to obtain a large vertical scan and a rotation over a small angular sector in order to have a finer graphical representation of the environment. Finally, the mobile 10 may comprise a plurality of other image capture devices positioned at different locations, to produce images according to one or more other orientations.

According to another embodiment, the mobile 10 with combined movement may comprise a digital image storage medium. The digital image storage medium is part of the cam 11.

According to another embodiment, the cam may be removable. In this case, if the storage medium is part of the cam, the body 9 may comprise a USB port situated substantially on the cam axis (X), and the cam 11 forms a USB key intended to be plugged into the USB port, for example situated inside the shaft connecting the cam to the motor unit.

The digital image storage medium is advantageously able to back up a succession of images produced as and when the cam 11 rotates about the cam axis X. It is then possible to cause the mobile 10 to effect a plurality of operating cycles in such a fashion that it backs up the succession of corresponding images. After the operating cycles have been carried out, the storage medium (where applicable the cam 11) containing the succession of images can furthermore be utilized to make the succession of images available to a user.

Alternatively, the mobile 10 may comprise cable or wireless communication means able to transmit the succession of images to a medium external to the mobile 10.

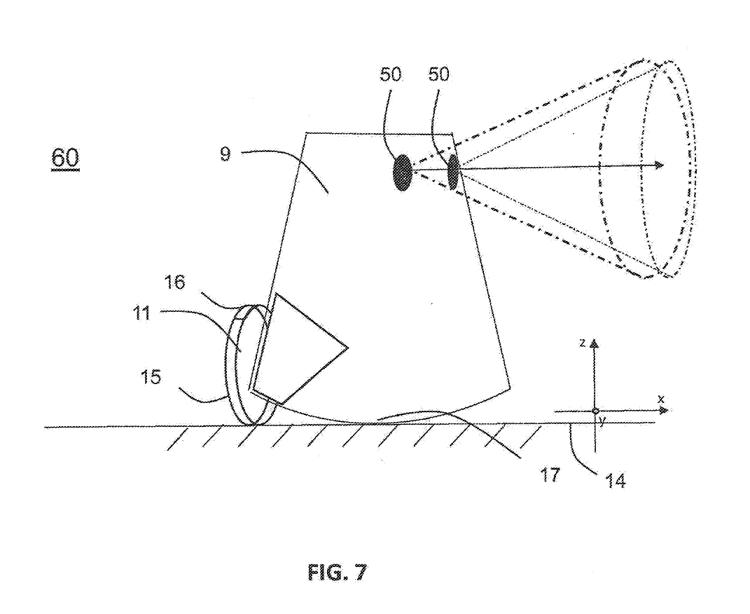

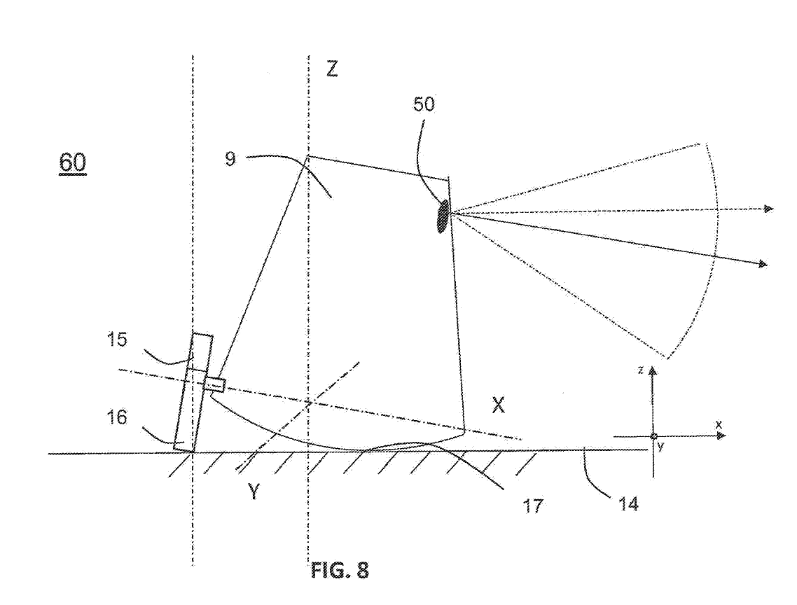

FIGS. 6, 7, 8 represent schematically another embodiment of the mobile with combined movement according to the invention. This embodiment of the mobile 60 with combined movement differs from the embodiment shown in FIGS. 3a to 3h in the shape of its body 9. In FIGS. 6, 7, 8, the body 9 has a substantially rounded base in such a fashion that the contact area 17 on the horizontal plane 14 forms a contact point, whatever the phase in which the mobile 60 with combined movement finds itself, that is to say in the phase of rotation about the vertical axis Z, as represented in FIGS. 6 and 7, or in a phase of rotation about the axis Y, as represented in FIG. 8. The body 9 is configured to rotate relative to the horizontal plane 14 about the vertical axis Z perpendicular to the cam axis X when the first portion 15 rolls without slipping on the horizontal plane 14 and to rotate relative to the horizontal plane 14 about the horizontal axis Y perpendicular to the cam axis X and the vertical axis Z when the second portion 16 slips without rolling on the horizontal plane 14.

The center of gravity of the mobile is advantageously situated on a vertical axis passing between the contact surface of the cam 11 with the horizontal plane 14 and the contact area 17 when the first portion 15 rolls without slipping on the horizontal plane 14. Accordingly, when the second portion 16 slips without rolling on the horizontal plane 14, the body 9 tilts forward, as represented in FIG. 8, without risk of falling forward.

This embodiment is particularly advantageous since the contact area 17 with the horizontal plane 14 is always a point, which allows a natural pivot effect to be obtained at the center of the mobile and not at the edge of the mobile. The result of this is improved stability of the mobile. Moreover, the natural pivot effect reduces the lever arm by a factor of approximately two and therefore the power of the motor necessary to set the cam in rotation can be divided by that factor.

FIGS. 9a, 9b, 9c, 9d represent schematically various cam configurations according to the invention. In the preceding representations, the cam 11 is represented in a substantially flattened form such as a disk. There is no departure from the scope of the invention with a two-dimensional or three-dimensional cam, for example of three-dimensional geometrical shape with a uniform or non-uniform contour.

The first portion 15 and the second portion 16 of the rolling surface 12 of the cam 11 each having a width, in an advantageous configuration, the width of the first portion 15 is greater than the width of the second portion 16, as represented in FIG. 9b. The first portion 15 is wider in order to produce a higher contact force when this portion is in contact with the horizontal plane 14. The second portion 16 may be narrower in order to minimize the contact between the cam 11 and the horizontal plane 14 and to encourage the slipping of the cam 11 on the horizontal plane 14.

FIGS. 9c and 9d represent cams in which the first portion 15 and the second portion 16 of the rolling surface 12 of the cam 11 are relatively wide, the width of the first portion 15 being greater than the width of the second portion 16 to encourage the contact with the horizontal plane 14.

In the extreme case, there may also be considered a cam like that represented in FIG. 9a. The width of the second portion 16 is minimized as much as possible in such a fashion that the cam 11 forms a point contact with the horizontal plane 14 when the second portion 16 is in contact with the horizontal plane 14. The width of the first portion 15 is greater than the width of the second portion 16.

Finally, the invention therefore comprises any cam of any shape having a first portion and a second portion that are distinct, each of the first and second portions having a different coefficient of friction, the coefficient of friction of the first portion being greater than the coefficient of friction of the second portion.

The invention allows a mobile of very simple structure, relatively compact and of relatively low cost, necessitating no particular maintenance, able to be mobile in rotation on itself and to be moved in vertical translation to be obtained. With an image capture device, a mobile of this kind allows a three-dimensional graphical representation of its environment to be obtained.

1. A mobile that can move on a horizontal plane, comprising:
a body comprising a contact area in contact with the horizontal plane
a cam movable in rotation relative to the body about a cam axis, the cam having a contact surface in contact with the horizontal plane during its rotation,
wherein the contact surface of the cam comprises separate first and second portions, each of the first and second portions having a different coefficient of friction, the coefficient of friction of the first portion being greater than the coefficient of friction of the second portion, the first portion being configured to roll without slipping on the horizontal plane the second portion being configured to slip without rolling on the horizontal plane, and in that the body is configured to rotate relative to the horizontal plane about a vertical axis perpendicular to the cam axis when the first portion rolls without slipping on the horizontal plane and to rotate relative to the horizontal plane about a horizontal axis perpendicular to the cam axis and to the vertical axis when the second portion slips without rolling on the horizontal plane.

2. The mobile as claimed in claim 1, wherein the cam is eccentric about the cam axis.

3. The mobile as claimed in claim 1, wherein the cam is a cylindrical wheel about a wheel axis, the cam axis being off-center relative to the wheel axis.

4. The mobile as claimed in claim 1, wherein the first portion extends over a first angular sector about the cam axis, and in that the first angular sector has a constant radius about the cam axis.

5. The mobile as claimed in claim 4, wherein the second portion extends over a second angular sector about the cam axis distinct from the first angular sector, defining two junction zones between the first angular sector and the second angular sector, and in that the radii relative to the cam axis of the first angular sector and the second angular sector vary continuously at the level of the two junction zones.

6. The mobile as claimed in claim 5, wherein the second angular sector comprises two zones of linear variation of the radius relative to an angle that the radius makes about the cam axis, a first of the two zones having a radius that increases linearly and a second of the two zones having a radius that decreases linearly.

7. The mobile as claimed in claim 1, wherein the contact area forms two individual points of contact with the horizontal plane.

8. The mobile as claimed in claim 7, wherein the contact area comprises two castors, and in that the two castors form the two individual points of contact with the horizontal plane.

9. The mobile as claimed in claim 1, wherein the body is configured so that the contact area forms an individual point of contact with the horizontal plane.

10. The mobile as claimed in claim 9, wherein the center of gravity of the mobile is situated on the vertical axis passing between the contact surface of the cam in contact with the horizontal plane and the contact area when the first portion rolls without slipping on the horizontal plane.

11. The mobile as claimed in claim 1, the first portion and the second portion of the rolling surface of the cam each having a width, wherein the width of the first portion is greater than the width of the second portion.

12. The mobile as claimed in claim 1, wherein it comprises at least one image capture device oriented along an orientation axis, able to produce an image of a sector situated about the orientation axis.

13. The mobile as claimed in claim 1, wherein it comprises a digital image storage medium.

14. The mobile as claimed in claim 13, wherein the digital image storage medium is part of the cam.

15. The mobile as claimed in claim 13, wherein the cam is removable.

16. The mobile as claimed in claim 13, wherein the body comprises a USB port situated substantially on the cam axis, and in that the cam forms a USB key intended to be plugged into the USB port.

17. The mobile as claimed in claim 13, wherein the digital image storage medium is able to back up a succession of images produced as and when the cam rotates about the cam axis.
